(19) United States
(12) Patent Application Publication
(10) Pub. No.: US 2026/0272738 A1
(43) Pub. Date: Sep. 17, 2026

(54) Electric Wheelchair

(71) Applicant: Wei-Ting Lin, Taichung City (TW)

(72) Inventor: Wei-Ting Lin, Taichung City (TW)

(21) Appl. No.: 19/080,733

(22) Filed: Mar. 14, 2025

(51) Int. Cl. A61G 5/06; A61G 5/04; A61G 5/08; A61G 5/10

(52) U.S. Cl. CPC A61G 5/068; A61G 5/042; A61G 5/08; A61G 5/104; A61G 5/1091; A61G 2203/14; A61G 2203/34; A61G 2203/42

(57) ABSTRACT

An electric wheelchair may include a seat assembly, a rear wheel assembly, and a front wheel assembly, and two power members are installed on the electric wheelchair to provide power for movement. The seat assembly has a chair frame, two handles on the chair frame, a user interface, a seat cushion, a backrest, a battery, and a main controller. The main controller is connected to a gyroscope and a speed sensor, and the gyroscope is adapted to detect the ground angle and transmit the detected data to the main controller, and based on the ground angle, the main controller is configured to extend or retract the rear wheel assembly. The battery is adapted to supply the necessary electrical power to the main controller, the rear wheel assembly, the front wheel assembly, and the power members for operation.

### FIELD OF THE INVENTION

The present invention relates to an electric wheelchair and more particularly to an electric wheelchair designed to provide a more comfortable and safer riding experience.

### BACKGROUND OF THE INVENTION

A wheelchair provides mobility for individuals with physical disabilities or limited mobility, such as the injured, patients, paraplegics, and the elderly. It also facilitates caregivers, including family members, long-term care providers, or medical personnel, in assisting with movement. Traditional wheelchairs rely on manual pushing, which not only requires significant effort but also limits speed. In response to these challenges, manufacturers have developed electric wheelchair structures equipped with motors and manual control levers, allowing for easier operation and enhanced mobility.

However, the conventional electric wheelchair has following disadvantages: Since the electric wheelchair moves at a higher speed, the inability to instantly detect and automatically adjust its elevation may pose a risk of tipping over due to a high center of gravity. When traveling uphill or downhill, users with limited physical strength may struggle to stabilize themselves, leading to excessive forward tilting or backward leaning during movement. This not only compromises comfort but also raises safety concerns for the user. Therefore, there remains a need for a new and improved design for an electric wheelchair to overcome the problems presented above.

### SUMMARY OF THE INVENTION

The present invention provides an electric wheelchair comprising a seat assembly, a rear wheel assembly, and a front wheel assembly, and two power members are installed on the electric wheelchair to provide power for movement. The seat assembly has a chair frame, two handles on the chair frame, a user interface, a seat cushion, a backrest, a battery, and a main controller. The main controller is connected to a gyroscope and a speed sensor, and the gyroscope is adapted to detect the ground angle and transmit the detected data to the main controller, and based on the ground angle, the main controller is configured to extend or retract the rear wheel assembly. The battery is adapted to supply the necessary electrical power to the main controller, the rear wheel assembly, the front wheel assembly, and the power members for operation. The rear wheel assembly comprises two support tube assemblies, which are installed on both sides of the rear portion of the chair frame and extend diagonally downward, and each of the support tube assemblies has an outer tube and an inner tube, and the outer tube and the inner tube are connected through a telescoping member. By activating the telescoping member, the inner tube is adapted to perform coaxial telescopic movement within the outer tube. Each of the support tube assemblies comprises a rear wheel pivotally mounted at the end thereof. The front wheel assembly has two actuators and two front wheel frames, and the two actuators are respectively installed on both sides of the front underside of the chair frame. Each of the two front wheel frames comprises a main section and an extension section, and the main section is horizontally positioned and is sleeved onto the actuator, so as to be driven by the actuator to have horizontal displacement. The extension section is adapted to extend diagonally downward from one end of the main section, so that the extension section and the support tube assembly are respectively diagonally extended downward to two opposite direction and gradually extended apart, and each of the extension sections is pivotally connected to a front wheel at the end thereof.

Comparing with conventional electric wheelchair, the present invention is advantageous because: (i) the seating angle of the electric wheelchair is adjustable through the rear wheel assembly to prevent excessive backward tilting on uphill slopes and forward tilting on downhill slopes, so as to ensure a comfortable ride; and (ii) when moving at higher speeds, the front wheel assembly automatically lowers the center of gravity of the seat assembly, so as to keep the electric wheelchair closer to the ground and reduce the risk of tipping over at high speeds, thereby significantly enhancing safety.

### BRIEF DESCRIPTION OF THE DRAWINGS

FIG. 1 is a top view of an electric wheelchair of the present invention.

FIG. 2 is a schematic view of the electric wheelchair of the present invention when going uphill.

FIG. 3 is a schematic view of the electric wheelchair of the present invention when going downhill.

FIG. 4 is a schematic view of the electric wheelchair of the present invention when a front wheel frame is extended.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

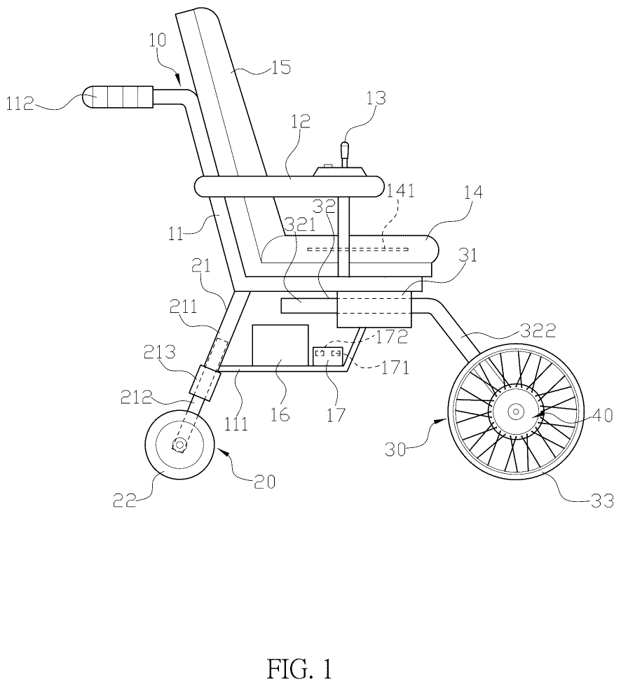

Referring to FIG. 1, the present invention provides an electric wheelchair comprising a seat assembly (10), a rear wheel assembly (20), and a front wheel assembly (30), and two power members (40) are installed on the electric wheelchair to provide power for movement. The seat assembly (10) has a chair frame (11), two handles (12) on the chair frame (11), a user interface (13), a seat cushion (14), a backrest (15), a battery (16), and a main controller (17). The main controller (17) is connected to a gyroscope (171) and a speed sensor (172), and the gyroscope (171) is adapted to detect the ground angle and transmit the detected data to the main controller (17), and based on the ground angle, the main controller (17) is configured to extend or retract the rear wheel assembly (20), so as to ensure the stability and balance while in motion. The battery (16) is adapted to supply the necessary electrical power to the main controller (17), the rear wheel assembly (20), the front wheel assembly (30), and the power members (40) for operation. The rear wheel assembly (20) comprises two support tube assemblies (21), which are installed on both sides of the rear portion of the chair frame (11) and extend diagonally downward, and each of the support tube assemblies (21) has an outer tube (211) and an inner tube (212), and the outer tube (211) and the inner tube (212) are connected through a telescoping member (213). By activating the telescoping member (213), the inner tube (212) is adapted to perform coaxial telescopic movement within the outer tube (211). Moreover, each of the support tube assemblies (21) comprises a rear wheel (22) pivotally mounted at the end thereof. The front wheel assembly (30) has two actuators (31) and two front wheel frames (32), and the two actuators (31) are respectively installed on both sides of the front underside of the chair frame (11). Furthermore, each of the two front wheel frames (32) comprises a main section (321) and an extension section (322), and the main section (321) is horizontally positioned and is sleeved onto the actuator (31), so as to be driven by the actuator (31) to have horizontal displacement. Also, the extension section (322) is adapted to extend diagonally downward from one end of the main section (321), so that the extension section (322) and the support tube assembly (21) are respectively diagonally extended downward to two opposite direction and gradually extended apart, and each of the extension sections (322) is pivotally connected to a front wheel (33) at the end thereof.

In one embodiment, the electric wheelchair is foldable.

In another embodiment, the chair frame (11) has a platform (111), and the battery (16) and the main controller (17) are securely installed on the platform (111).

In still another embodiment, the chair frame (11) comprises a handle (112) installed thereon to allow the electric wheelchair to be operated manually by pushing.

In a further embodiment, the chair frame (11) has a footrest (not shown in FIGs.) to allow an accompanying caregiver to stand on the footrest and be transported forward by the electric wheelchair.

In still a further embodiment, the user interface (13) is used to provide control for the rider, so that the rider is adapted to control the electric wheelchair's movement, including forward, backward, and turning, and the user interface (13) is a joystick control interface, a button control interface, or a panel control interface.

In a preferred embodiment, the seat cushion (14) has a pressure film (141) installed therein to detect whether the rider is seated on the cushion, and when the rider is properly seated, the pressure film (141) is configured to activate the main controller (17) to initiate operation.

In another preferred embodiment, the gyroscope (171) and the speed sensor (172) are directly installed on the main controller (17).

In an advantageous embodiment, the support tube assembly (21) is an electric cylinder.

In another advantageous embodiment, the actuator (31) is a servo motor with a gear (not shown in FIGs.), and the main section (321) of the front wheel frame (32) comprises a teeth portion (not shown in FIGs.), and the gear is engaged with the teeth portion, so that the front wheel frame (32) is smoothly driven and translated by the actuators (31).

In still another advantageous embodiment, the size of the front wheel (33) is larger than that of the rear wheel (22).

In a particular embodiment, the front wheels (33) have a 16-inch diameter.

In another particular embodiment, the two power members (40) are hub motors respectively installed on the two front wheels (33).

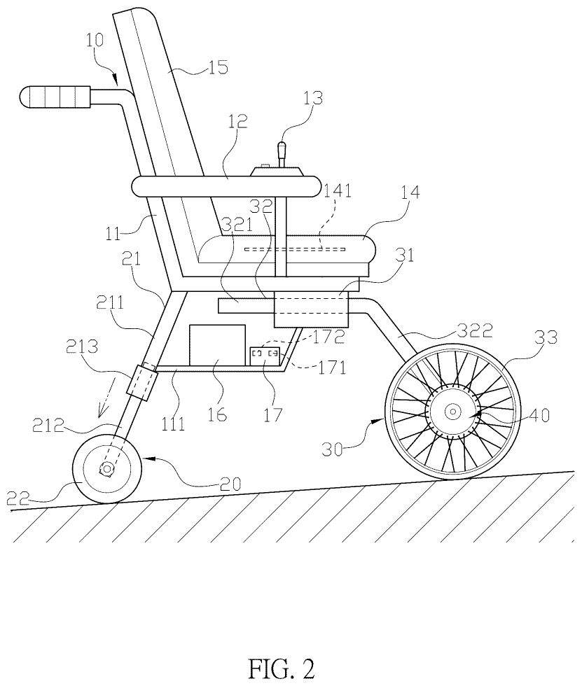

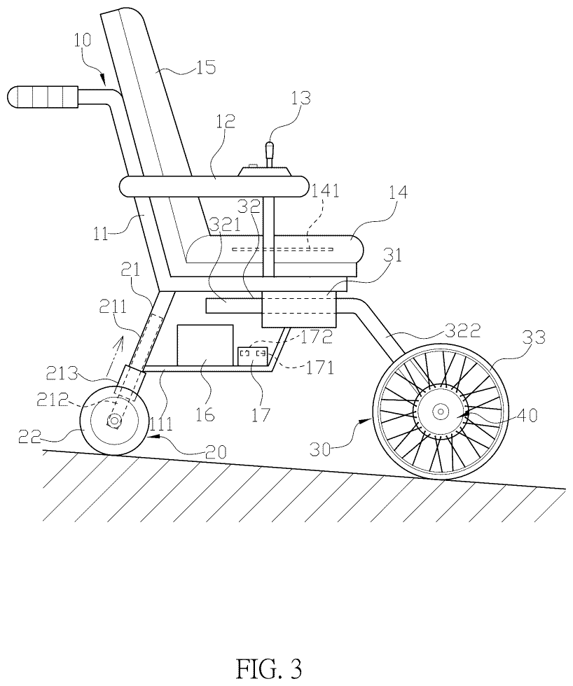

In actual application, when encountering an uphill slope, the gyroscope (171) detects the road angle and sends the data to the main controller (17), and the main controller (17) is configured to active the telescoping member (213) to extend the inner tube (212) (as shown in FIG. 2), ensuring that the seat cushion (14) remains in a horizontal position, so as to prevent the rider from excessively tilting backward. Conversely, when encountering a downhill slope, the gyroscope (171) detects the road angle and transmits the data to the main controller (17), and the main controller (17) is adapted to activate the telescoping member (213) to significantly retract the inner tube (212) (as shown in FIG. 3), ensuring that the seat cushion (14) remains in a horizontal position, so as to prevent the rider from excessively tilting forward.

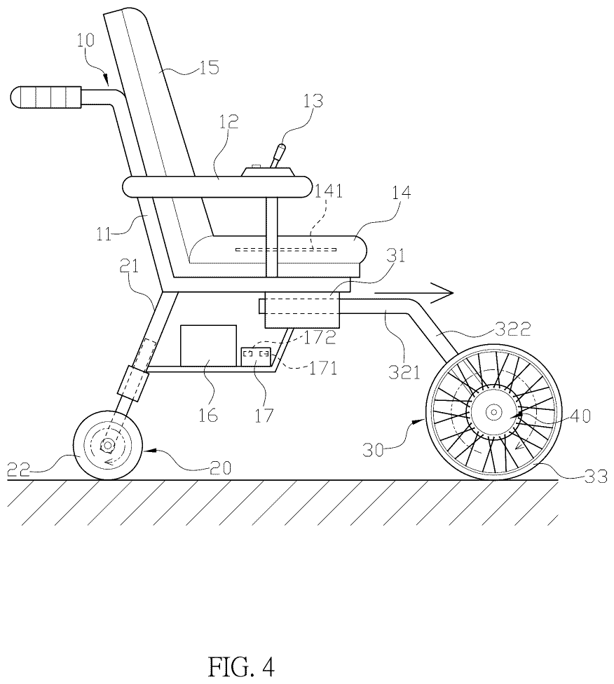

Referring to FIG. 4, when the speed sensor (172) detects that the electric wheelchair is moving too fast (preset at 10 km/h), the main controller (17) is configured to activate the actuators (31) to move and extend the front wheel frame (32) forward, so that the distance between the front wheels (33) and the rear wheels (22) is increased and also the seat assembly (10) is lowered. With the lower center of gravity design, the electric wheelchair maintains balance and stability even at high speeds, significantly enhancing safety during use.

Comparing with conventional electric wheelchair, the present invention is advantageous because: (i) the seating angle of the electric wheelchair is adjustable through the rear wheel assembly (20) to prevent excessive backward tilting on uphill slopes and forward tilting on downhill slopes, so as to ensure a comfortable ride; and (ii) when moving at higher speeds, the front wheel assembly (30) automatically lowers the center of gravity of the seat assembly (10), so as to keep the electric wheelchair closer to the ground and reduce the risk of tipping over at high speeds, thereby significantly enhancing safety.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. An electric wheelchair comprising a seat assembly, a rear wheel assembly, and a front wheel assembly, and two power members installed on the electric wheelchair to provide power for movement;
wherein the seat assembly has a chair frame, two handles on the chair frame, a user interface, a seat cushion, a backrest, a battery, and a main controller; the main controller is connected to a gyroscope and a speed sensor, and the gyroscope is adapted to detect the ground angle and transmit the detected data to the main controller, and based on the ground angle, the main controller is configured to extend or retract the rear wheel assembly; the battery is adapted to supply the necessary electrical power to the main controller, the rear wheel assembly, the front wheel assembly, and the power members for operation;
wherein the rear wheel assembly comprises two support tube assemblies, which are installed on both sides of the rear portion of the chair frame and extend diagonally downward, and each of the support tube assemblies has an outer tube and an inner tube, and the outer tube and the inner tube are connected through a telescoping member; by activating the telescoping member, the inner tube is adapted to perform coaxial telescopic movement within the outer tube; each of the support tube assemblies comprises a rear wheel pivotally mounted at the end thereof;
wherein the front wheel assembly has two actuators and two front wheel frames, and the two actuators are respectively installed on both sides of the front underside of the chair frame; each of the two front wheel frames comprises a main section and an extension section, and the main section is horizontally positioned and is sleeved onto the actuator, so as to be driven by the actuator to have horizontal displacement; the extension section is adapted to extend diagonally downward from one end of the main section, so that the extension section and the support tube assembly are respectively diagonally extended downward to two opposite direction and gradually extended apart, and each of the extension sections is pivotally connected to a front wheel at the end thereof.

2. The electric wheelchair of claim 1, wherein the electric wheelchair is foldable.

3. The electric wheelchair of claim 1, wherein the chair frame has a platform, and the battery and the main controller are securely installed on the platform.

4. The electric wheelchair of claim 1, wherein the chair frame comprises a handle installed thereon.

5. The electric wheelchair of claim 1, wherein the user interface is a joystick control interface.

6. The electric wheelchair of claim 1, wherein the seat cushion has a pressure film installed therein to connect to the main controller.

7. The electric wheelchair of claim 1, wherein the gyroscope and the speed sensor are directly installed on the main controller.

8. The electric wheelchair of claim 1, wherein the support tube assembly is an electric cylinder.

9. The electric wheelchair of claim 1, wherein the size of the front wheel is larger than that of the rear wheel.

10. The electric wheelchair of claim 1, wherein the two power members are hub motors respectively installed on the two front wheels.
